(19) United States
(12) Patent Application Publication
(10) Pub. No.: US 2012/0204737 A1
(43) Pub. Date: Aug. 16, 2012

(54) Tracking Bale Density Door for Big Square Baler

(75) Inventors: Brian Olander, Buhler, KS (US); Edward W. Esau, Hesston, KS (US); Patrick Kendrick, Hesston, KS (US); Robert A. Matousek, Milan, IL (US)

(73) Assignee: AGCO CORPORATION, Duluth, GA (US)

(21) Appl. No.: 13/337,402

(22) Filed: Dec. 27, 2011

Related U.S. Application Data
(60) Provisional application No. 61/427,293, filed on Dec. 27, 2010.

(51) Int. Cl. A01F 15/08; A01F 15/04

(52) U.S. Cl. 100/35; 100/178; 100/222

(57) ABSTRACT

In one embodiment, bale density door system of a baler, comprising: plural bale density doors defining a chamber, the chamber comprising a front end and a rear end; and plural tracking surfaces associated with a portion of the plural bale density doors, the plural tracking surfaces moveable in a direction from the front end to the rear end.

### RELATED APPLICATION

Under provisions of 35 U.S.C. §119(e), Applicants claim the benefit of U.S. provisional application No. 61/427,293, filed Dec. 27, 2010, which is incorporated herein by reference.

### TECHNICAL FIELD

The present disclosure generally relates to a baler, and in particular, compression of bales in square balers.

### BACKGROUND

Baling operations can follow combine harvester operations or windrow operations. In the former instance, a baler may be towed by a combine harvester or by a tractor to gather cut crops such as plant stalks from a field to form the plant stalks into round or square bales. Biomass fuels such as straw, hay, or cereals may be formed into bales. In the latter instance, a baler may pick up windrows that were created by a mower-conditioner.

### SUMMARY

In one embodiment, a bale density door system of a baler, comprising: plural bale density doors defining a chamber, the chamber comprising a front end and a rear end; and plural tracking surfaces associated with a portion of the plural bale density doors, the plural tracking surfaces moveable in a direction from the front end to the rear end.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates a square baler towed by a combine harvester, the square baler comprising an embodiment of a bale density door system.

FIG. 2A is a block diagram that illustrates a front elevation view of an example baling chamber of an embodiment of a bale density door system with a square bale located between example tracking surfaces associated with opposing upstanding bale density doors.

FIG. 2B is a block diagram of an internal, side elevation view of an example tracking surface of an embodiment of a bale density door system, the tracking surface associated with one of the upstanding bale density doors and moveable along two rollers at opposing ends of the tracking surface.

FIG. 2C is a block diagram of an internal, side elevation view of another example tracking surface of an embodiment of a bale density door system, the tracking surface associated with one of the upstanding bale density doors and moveable along four rollers distributed along a length of the tracking surface.

FIG. 3 is a block diagram of an internal, side elevation view of plural tracking surfaces of an embodiment of a bale density door system, the plural tracking surfaces separated by a gap.

FIG. 4A is a plan view of an example smooth tracking surface of an embodiment of a bale density door system.

FIG. 4B is a plan view of an example tracking surface of an embodiment of a bale density door system with protrusions extending out from the surface.

FIG. 5 is a block diagram that illustrates a front elevation view of another example baling chamber of an embodiment of a bale density door system that illustrates a smaller cross-sectional outlet opening toward the rear of the baling chamber when compared to the front inlet opening of the baling chamber, the example baling chamber comprising top and bottom tracking surfaces.

FIG. 6 is a block diagram that illustrates a front elevation view of another example baling chamber of an embodiment of a bale density door system similar to one shown in FIG. 2A yet with a single motive apparatus to drive one tracking surface and coupled to a drive mechanism to drive an opposing tracking surface.

FIG. 7 is a flow diagram that illustrates an embodiment of a bale density door method.

### DETAILED DESCRIPTION

Certain embodiments of a bale density door system and associated methods are disclosed. The bale density door system comprises a surface or surfaces that track with (move with or substantially with) a bale as it moves through a bale chute or chamber. Such tracking surfaces are associated with plural bale density doors (e.g., opposing steel doors, such as top and bottom, left and right side, or a combination of all sides or a subset thereof). The tracking surfaces reduce or eliminate the friction between the bale and the opposing tracking bale density doors, enabling the tracking bale density doors to be closed further than conventional bale density doors without obstructing (e.g., constipating) the bale. Since the bale density doors can be closed further, the bale may be extruded through a smaller cross-sectional area of the chamber, increasing the density of the bale.

Conventional bale density doors of a big square baler have a solid plate that squeezes the bale as the plunger pushes the bale through the chamber. The amount of squeeze controls the force exerted by a plunger as the bale is formed. For instance, there is a limit to how much the bale density doors can be squeezed down where the plunger can no longer move the bale and the bale becomes constipated. If the bale density doors could close the chamber further while still allowing the bale to move through the chamber, the extruded sectional area of the bale could decrease, and the bale density could increase. Certain embodiments of a bale density door system address these and other issues.

The following detailed description refers to the accompanying drawings. Wherever possible, the same reference numbers are used in the drawings and the following description to refer to the same or similar elements. While certain embodiments of the disclosure may be described, modifications, adaptations, and other implementations are possible as should be understood by one having ordinary skill in the art in the context of the disclosure. For example, substitutions, additions, or modifications may be made to the elements illustrated in the drawings, and the methods described herein may be modified by substituting, reordering, or adding stages to the disclosed methods. References hereinafter made to certain directions, such as, for example, “front”, “rear”, “left” and “right”, are made as viewed from the rear of the round baler looking forwardly.

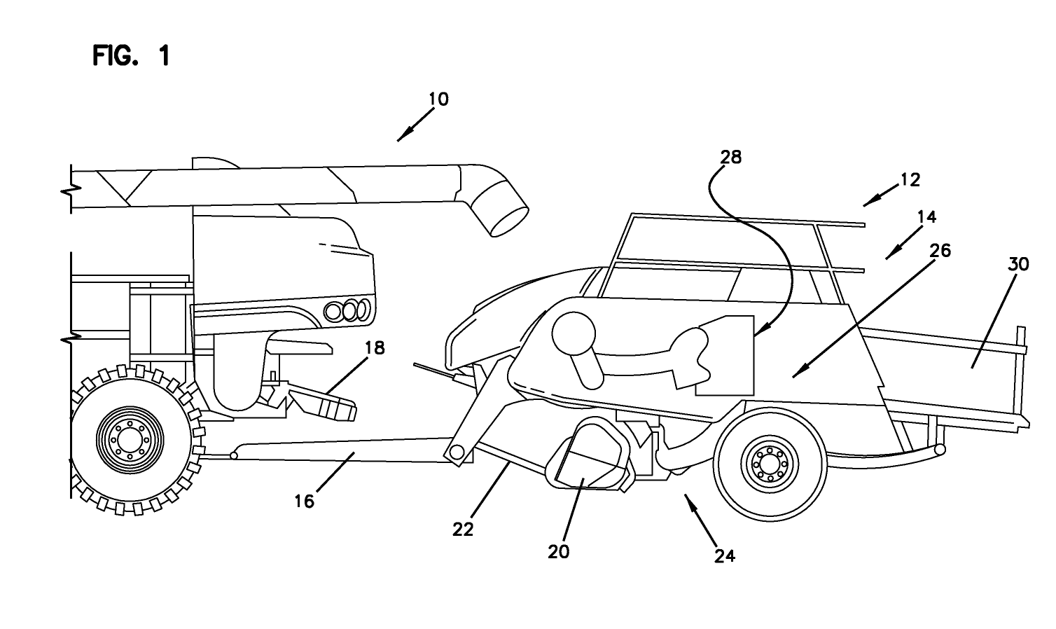

Referring to FIG. 1, shown is an example combine harvester 10 (herein, also referred to as a combine) and a big square baler 12 (herein also referred to as a baler) towed by the combine 10, the baler 12 housing certain embodiments of the bale density door system 14. It should be understood by one having ordinary skill in the art, in the context of the present disclosure, that the example components illustrated in FIG. 1 are merely illustrative, and should not be construed as implying any limitations upon the scope of the disclosure. For instance, in some embodiments, a tractor or other vehicle may be used to tow the baler 12, or in some embodiments, the baler 12 may be self-propelled. The baler 12 in the illustrated embodiment is pivotally attached to the rear of the combine 10 via a tongue 16, which is coupled to a hitch point located at the rear of the combine 10. As is known, the baler 12 may be powered by a hydrostratic motor affixed to a flywheel of the baler 12 drawing its power source from an engine of the combine 10 via, for instance, a hydrostatic pump.

In some implementations, the tongue 16 may be coupled to the combine 10 in a manner that enables crop material (e.g., biomass, such as straw) from the combine 10 to be transferred from the combine 10 directly to the baler 12 without redirection through the air by the combine 10 and without the use of a conveyor (or other transfer mechanism) coupled to either the combine 10 or the baler 12. For instance, the combine 10 may disburse crop material from a tailboard 18 at an angle of trajectory that enables the crop material to fall onto a component (e.g., pan) of the baler 12, the crop material then transferred to a pickup 20 of the baler 12 via a transfer pan 22. In some embodiments, other mechanisms of crop pickup may be used. For instance, the crop material may be lifted or received from the ground with the pickup 20. The pickup 20 may be a rotating drum-type mechanism with flexible tines or teeth for lifting and conveying crop material from the ground to the baler 12. Packing forks (not shown) can grab at least a portion of the crop material collected on the transfer pan 22 and move the crop material back to a pre-compression chamber 24.

A stuffer arm assembly includes a fork disposed along the width of the pre-compression chamber 24 to engage the crop material and deliver the crop material as a flake or charge through the pre-compression chamber 24 past a top, retractable opening (e.g., holding fingers) of the pre-compression chamber 24 to a baling chamber 26 (shown in partial cut-away) of the bale density door system 14. The charge or charges are compressed into a bale 30 by a reciprocating plunger 28 (shown in a fragmentary view via a partial cut-away of the baler 12) in cooperation with mechanisms of the bale density door system 14, the bale 30 optionally knotted or meshed in the baling chamber 26 (herein, also referred to merely as chamber) for subsequent discharge of the bale 30 (with or without knotting) from the rear of the baler 12. As the pickup, packing, and plunging operations are known to those having ordinary skill in the art, discussion of the same are omitted hereinafter for brevity.

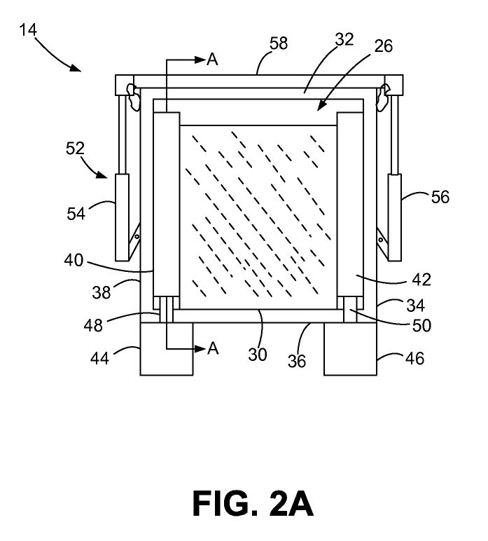

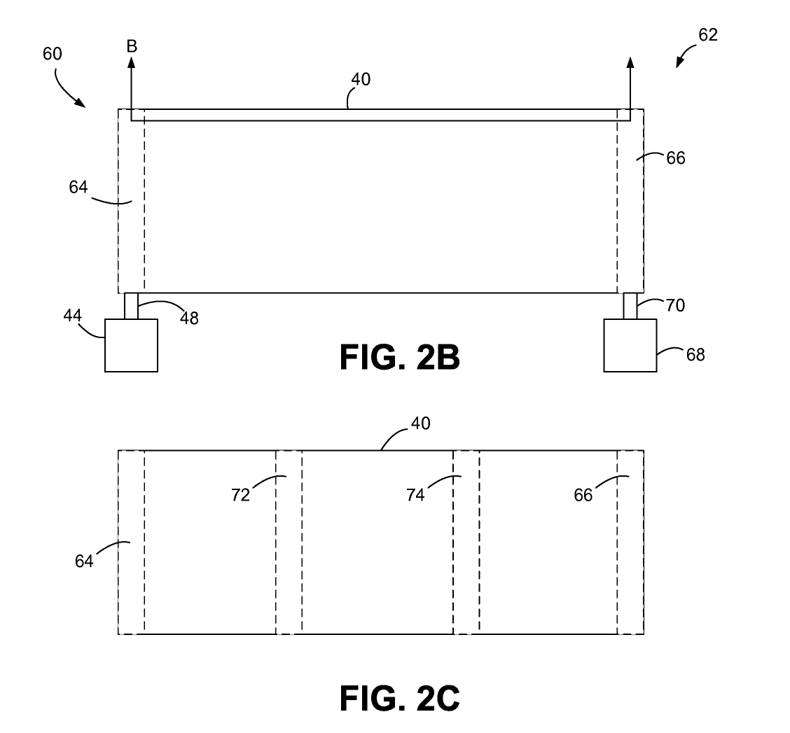

Having described an example baler 12 in which one or more embodiments of a bale density door system 14 and associated methods may be employed, attention is directed to FIG. 2A, which is an example bale density door system 14 shown in a front elevation view. It should be understood that the bale density door system 14 is for illustrative, non-limiting purposes, and that other configurations for the bale density door system 14 are contemplated to be within the scope of the disclosure, including single-tracking surface embodiments. The bale density door system 14 comprises plural bale density doors, including a top 32, upstanding side 34 (shown on the right in FIG. 2A, though in fact a left hand side vertical or upstanding door when viewed from the rear), bottom 36, and upstanding side 38 (right hand side vertical door) bale density doors. Associated with the bale density doors 38 and 34 are tracking surfaces 40 and 42, respectively. The tracking surfaces 40 and 42 comprise a belt (e.g., of an elastomeric material, such as rubber) or in some embodiments, a chain and slat assembly, among other options, that move concurrently with (e.g., track) the bale 30 as the bale moves through the chamber 26. The tracking surfaces 40 and 42 are moveable over plural rollers (hidden from view by the tracking surfaces 40 and 42) associated with each of the tracking surfaces 40 and 42, the plural rollers actuated for each surface 40, 42 via motive apparatuses 44 and/or 46, respectively. In one embodiment, the rollers are attached to the doors via a respective bearing, and allowed to rotate along their axis. The motive apparatuses 44 and 46 drive a respective shaft 48 and 50, the shafts 48 and 50 frictionally coupled to the rollers. In one embodiment, motive apparatuses 44 and 46 may comprise electric motors, though other mechanisms may be used in some embodiments such as hydraulics or pneumatics as the motive force. In some embodiments, a single motive apparatus 44 or 46 may be employed, as is described below.

In one embodiment, compression of the bale 30 is achieved, at least in part, by a compression assembly 52 comprising hydraulic cylinders 54 and 56 that are each coupled to the doors 38 and 34 via bell cranks 58A and 58B. Note that other mechanisms may be employed to accommodate compression, and that in some embodiments, the compression assembly 52 may be omitted. Further, the features shown in FIG. 2A for the bale density door system 14 are for illustration, and not intended to limit the structure of the bale density door system 14. The compression assembly 52 squeezes (inward) the bale density doors 34 and 38 and hence draws tracking surfaces 40 and 42 against the bale 30. As the general manner of compression performed by the compression assembly 52 is known in the art, its operation in the context of the present disclosure should now be apparent and hence further discussion of the same is omitted hereinafter.

In operation, the bale 30 moves (via plunger movement) along a longitudinal axis through the chamber 26 and concurrently with the moving tracking surfaces 40 and 42 located on each side of the bale 30. Note that in some embodiments, reference is made to the first and second tracking surfaces moveable in a direction substantially parallel to the longitudinal axis. It should be understood in the context of the present disclosure that, in one embodiment, substantially parallel refers to a direction that is indeed parallel to the longitudinal axis, particularly with a uniform cross section for the chamber 26. In some embodiments, including but not limited to a narrowing of the chamber cross section (and hence a slope defined by an angular dimension relative to a longitudinal axis where there is no sloping of the chamber 26), substantially parallel may refer to a direction (e.g., angular dimension of a slope as the chamber narrows) of no greater than twenty-five degrees (≦25°). In some embodiments, substantially parallel refers to an angular dimension of the slope of no greater than fifteen degrees (≦15°), and in some embodiments, substantially parallel refers to an angular dimension of the slope of no greater than ten degrees (≦10°). The tracking surfaces 40 and 42 are actuated by the motive apparatuses 44 and 46 causing rotation of respective shafts 48 and 50, the shafts frictionally coupled to the rollers (obscured from view) which rotate to cause movement of the tracking surfaces 40 and 42. Note that, although the illustrated bale density door system embodiment is described in a manner where the tracking surfaces 40 and 42 are actuated/powered (e.g., assisting the plunger 28 in moving the bale 30 through the chamber 26, which reduces the load of the plunger 28), other implementations are contemplated. For instance, in some implementations, the tracking surfaces 40 and 42 may be unpowered, where movement of the bale 30 is purely by virtue of plunger movement.

As another example, some implementations may utilize a braking action established by the motive apparatuses 44 and 46 that creates a frictional force that opposes the plunger force. Digressing briefly, conventional designs use the friction generated between the sliding of the bale against the side doors to generate a braking action on the bale. This braking action, in turn, creates a restriction for plunger-effected movement of each flake used to pack a bale. If more force is needed, the doors are squeezed further, creating more friction, and thus more braking action (and more plunger force). In certain embodiments of bale density door systems 14, however, the tracking surfaces 40 and 42 track with the bale 30, resulting in minimal or no sliding between the tracking surfaces and the bale. Accordingly, when needed for adequate plunger force, a braking force is applied to the rollers associated with the tracking surfaces 40 and 42. Such a braking force may be implemented via a hydraulic or pneumatic circuit that is coupled to the motive apparatuses 44 and/or 46. For instance, and without limitation, the hydraulic circuit may deliver (e.g., from a reservoir) a variable amount of hydraulic fluid to the motive apparatuses 44 and 46 based on the desired speed, as well as providing an adjustable back pressure (e.g., resistance) on the motive apparatuses 44 and 46 to increase or decrease the braking force. The braking force may be coupled with squeezing of the upstanding bale density doors 38 and 34 and hence squeezing of the tracking surfaces 40, 42 by the compression assembly 52 against each side of the bale 30 while the plunger 28 continues to introduce charges for against the bale 30. In some embodiments, the compression may be achieved without the use of the compression assembly 52. These and other manners of operation of the bale density door system 14 may be accomplished through operator adjustment, such as via mechanical controls or controls actuated through actuation of push-button or touch screen controls at an operator console of, for instance, the combine harvester 10. For instance, the operator may make such adjustments based on the crop to be baled and/or the desired bale density. In some embodiments, the manner of operation may be automated, based on feedback of certain operational and/or environmental parameters.

Attention is now directed to FIG. 2B, which illustrates a cross section along lines A-A (FIG. 2A) of the length of the tracking surface 40. It should be appreciated that the features of tracking surface 40 and the associated components are similar (e.g., mirrored, except where omitted) to the tracking surface 42 and associated components, and hence discussion of tracking surface 42 is omitted to facilitate a clear understanding of the bale density door system 14 without undue complication. A forward end 60 of the tracking surface 40 is proximal to the entry end of the chamber 26, and a rear end 62 of the tracking surface 40 is proximal to the exit end of the chamber 26 from where the bale 30 is discharged. In one embodiment, the tracking surface 40 is moveable over a roller 64 (shown in phantom) at the forward end 60, and further moveable over a roller 66 (shown in phantom) at the rear end 62. In one embodiment, the roller 66 is actuated via a shaft 70, which is rotated by a motive apparatus 68 (e.g., electric motor) in similar manner to the motive apparatus 44 and shaft 48 assembly described previously, and hence discussion of the same is omitted here for brevity. In some embodiments, the motive apparatus 68 and corresponding shaft 70 may be omitted. For instance, the roller 66 may be an idler roller or free to turn on its own.

Other configurations in the manner of enabling movement of the tracking surface 40 (and similarly 42) are contemplated to be within the scope of the disclosure. For instance, shown in FIG. 2C (with some components as shown in FIG. 2B omitted) is the tracking surface 40, with movement over actuated rollers 64 and 66 (one of the rollers may be implemented without an associated motive apparatus), where the rollers 64 and 66 are shown in phantom as shown in FIG. 2B, and further comprising additional rollers, such as rollers 72 and 74 (shown in phantom) located between rollers 64 and 66. In some embodiments, rollers 72 and/or 74 may be associated with a motive apparatus (e.g., driven), and in some embodiments, the rollers 72 and/or 74 move freely (e.g., no actuation or not driven). Other quantities of rollers may be used in some embodiments.

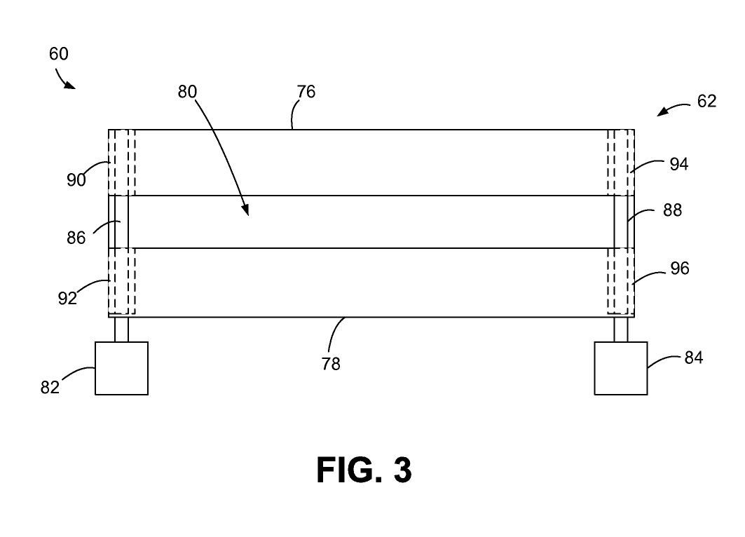

FIG. 3 shows an example embodiment of plural (two in this example, though other quantities are contemplated) tracking surfaces 76 and 78 run adjacently lengthwise (e.g., and shown in a similar, side elevation view as shown for tracking surface 40 in FIG. 2B), where each surface 76 and 78 is separated in between by a gap 80. As noted, the surfaces 76 and 78 are driven by motive apparatuses 82 and 84 located proximally to ends 60 and 62, respectively. As noted above, one or the other motive apparatus 82, 84 may be omitted in some embodiments. The motive apparatuses 82 and 84 are similarly configured to motive apparatuses 44 and 46. The motive apparatuses 82 and 84 drive respective shafts 86 and 88 (shown partially in phantom where obscured by the surfaces 76 and 78), which cause rotation of the shafts. Rotation of the shaft 86 causes rotation of rollers 90 and 92 (frictionally fit onto shaft 86, and shown in phantom). Rotation of shaft 88 causes rotation of rollers 94 and 96 (frictionally fit onto shaft 88, and shown in phantom). It is noted that rollers 90, 92, 94, and 96 are of smaller profile that rollers 64 and 66.

In some embodiments, rollers 90, 92 may be replaced with roller 64 (e.g., regular profile), and rollers 94, 96 may be replaced with roller 66. In some embodiments, another independent motive apparatus may be used for top-side rollers 90 and 94 instead of using the motive apparatuses 82 and 84, respectively, used by rollers 92 and 96. It should be appreciated that similar configurations are contemplated for the opposite side tracking surface, where not omitted, and hence discussion of the same is omitted here.

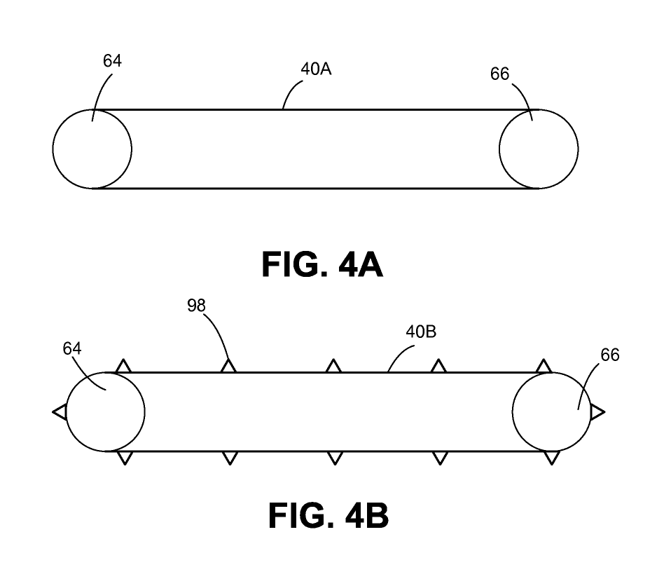

FIGS. 4A-4B are cross-sectional views along lines B-B of FIG. 2B for different tracking surface embodiments. For instance, with reference to FIG. 4A, shown is a tracking surface 40A moveable around rollers 64 and 66 and having a smooth surface, such as an endless belt (or endless band, where band and belt are used interchangeably herein). In contrast, FIG. 4B shows a tracking surface 40B moveable around rollers 64 and 66, and having protrusions 98 extending from the surface. For instance, tracking surface 40B may be configured as an endless chain or belt, and the protrusions 98 may comprise plural slats distributed uniformly along the length of the surface 40B (or in some embodiments, of more of a random, irregular pattern), among other protrusions and arrangements. In some embodiments, the rollers may be replaced with another cylindrical object, such as a shaft. It should be appreciated that some known features are omitted where unnecessary to the understanding of the embodiments of the disclosure. In some embodiments, variants of the above surfaces may be employed, such as an elastomeric belt with a rough surface.

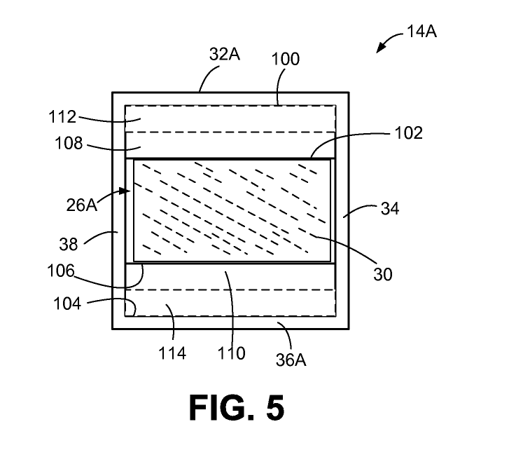

FIG. 5 illustrates another embodiment for a bale density door system 14A, where a front elevation view reveals a difference in cross section of the chamber 26 between the front end and the rear end. The bale density door system 14A includes a chamber 26A defined by bale density doors 32A, 34, 36A, and 38. In particular, the chamber 26A is characterized by sloping top and bottom bale density door 32A, 36A, respectively, such that the internal surface 100 of the bale density door 32A (exposed to the passageway of the chamber 26A, and not the outside) at the front end of the chamber 26A slopes to a lower elevation point 102 at the rear end of the chamber 26A (e.g., gradually narrows in terms of chamber height dimension from front to rear, and hence results in a smaller cross section at the rear end compared to the front end of the chamber 26A).

Similarly, the internal surface 104 of the bale density door 36A slopes up to an elevation point 106 in a manner that results in a narrowing of the chamber cross section when advancing from the front to the rear end of the chamber 26A. Further, it is noted that in the illustrated embodiment, the tracking surfaces 108 and 110 are associated with the top 32A and bottom 36A bale density doors, and not associated with the side upstanding bale density doors 34 and 38 as in previous embodiments. Rollers 112 and 114 (shown in phantom) enable movement of the tracking surfaces 108 and 110, in similar manner of operation and actuation to like-named components described above.

In operation, the bale 30 is pushed rearward through the chamber 26A and tracked by moving tracking surfaces 108 and 110, the motion of the tracking surfaces 108 and 110 enabling smaller cross sections at the outlet of the chamber 26A since the risk of constipation is reduced when compared to conventional systems. Similar variations in operations (e.g. via operator intervention, or in some embodiments, automated based on sensor feedback) and controls/actuation (e.g., braking, compression) to those discussed above in association with FIG. 2A are contemplated for one or more embodiments associated with the bale density door system 14A illustrated in FIG. 5. Further, though illustrated using changes in elevation from front to rear for top 32A and bottom 36A density doors, other and/or additional density door elevation changes (e.g., for different bale density doors or additional doors) resulting in a reduced cross section for the chamber passageway are contemplated to be within the scope of the embodiments. In addition, some embodiments may use a combination of top, bottom, and opposing side tracking surfaces, or a subset of the entire combination in some embodiments, with one or more motive apparatuses as described above.

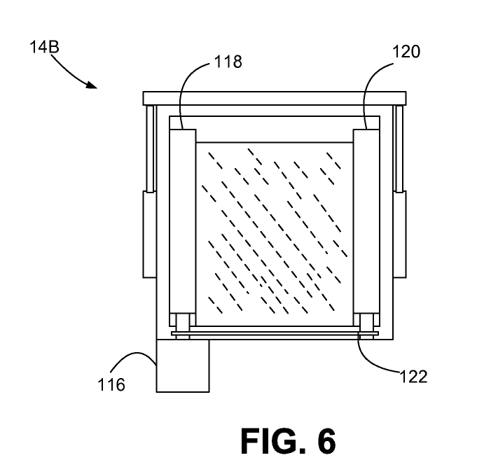

FIG. 6 is another embodiment of a bale density door system 14B, where a single motive apparatus 116 (with associated shaft, similar to previously described motive apparatuses) is used to move tracking surfaces 118 and 120 (similar to previously described tracking surfaces) via a drive mechanism 122. The drive mechanism 122, configured in one embodiment as a drive chain assembly, conveys the rotational power of the motive apparatus 116 that is directly applied to the tracking surface 118 to the shaft associated with the tracking surface 120. In some embodiments, additional tracking surfaces may be driven by the same or a different drive mechanism.

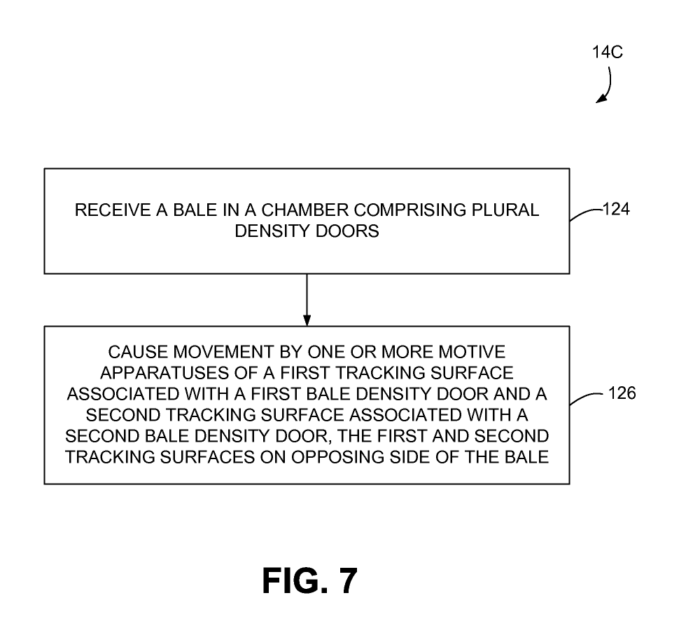

Having described certain embodiments of the bale density door system 14 (and 14A, 14B), it should be appreciated, in the context of the present disclosure, that one embodiment of a bale density door method 14C, illustrated in FIG. 7, comprises receiving a bale in a chamber comprising plural density doors (124); and causing movement by one or more motive apparatuses of a first tracking surface associated with a first bale density door and a second tracking surface associated with a second bale density door, the first and second tracking surfaces on opposing side of the bale (126).

It should be emphasized that the above-described embodiments of the present disclosure are merely possible examples of implementations, merely set forth for a clear understanding of the principles of the bale density door system and method embodiments. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

What is claimed is:

1. A bale density door system of a baler, comprising:
plural bale density doors defining a chamber, the chamber comprising a first end and a second end along a longitudinal axis of the chamber, the chamber comprising a rectangular cross section through which a bale may pass from the first end to the second end; and
a first tracking surface and a second tracking surface associated with a first door and a second door, respectively, of the plural bale density doors, the first and second tracking surfaces moveable in a direction substantially parallel to the longitudinal axis.

2. The system of claim 1, further comprising plural rollers associated with the first and second tracking surfaces, wherein the first and second tracking surfaces are moveable over the associated rollers.

3. The system of claim 2, wherein a first roller of the plural rollers associated with the first tracking surface is operably coupled to a first motive apparatus, the first roller proximal to the first end.

4. The system of claim 3, wherein a second roller of the plural rollers associated with the first tracking surface is operably coupled to either the first motive apparatus or a second motive apparatus, the second roller proximal to the second end.

5. The system of claim 4, further comprising first and second rollers of the plural rollers associated with the second tracking surface, the first and second rollers proximal to the first and second ends and operably coupled to either the first motive apparatus or respective third and fourth motive apparatuses.

6. The system of claim 1, wherein the cross section of the chamber is larger at the first end than at the second end.

7. The system of claim 1, wherein the first and second tracking surfaces are further moveable in a direction perpendicular to the longitudinal direction to compress the bale.

8. The system of claim 1, wherein the first and second tracking surfaces each comprise either a belt, or a chain with slats.

9. The system of claim 1, wherein the first and second tracking surfaces each comprise additional tracking surfaces, the additional tracking surfaces separated from each other along a directional perpendicular to the longitudinal direction by a gap.

10. The system of claim 1, wherein the first and second tracking surfaces are associated with respective first and second substantially upstanding bale density doors of the plural bale density doors, the respective first and second upstanding bale density doors opposing each other.

11. The system of claim 1, wherein the first and second tracking surfaces are associated with respective first and second substantially horizontal bale density doors of the plural bale density doors, the respective first and second horizontal bale density doors opposing each other.

12. A bale density door system of a baler, comprising:
plural bale density doors defining a chamber, the chamber comprising a front end and a rear end; and
plural tracking surfaces associated with a portion of the plural bale density doors, the plural tracking surfaces moveable in a direction from the front end to the rear end.

13. The system of claim 12, wherein the plural tracking surfaces move on rollers or a shaft when the plural tracking surfaces are configured in a chain and slat configuration.

14. The system of claim 13, wherein at least a portion of the rollers are actuated by one or more motive apparatuses associated with each of the plural tracking surfaces.

15. The system of claim 12, wherein a cross section of the chamber is larger at the front end than at the rear end.

16. The system of claim 12, wherein the plural tracking surfaces are moveable in a direction perpendicular to the direction defined from the front end to the rear end.

17. The system of claim 12, wherein a first of the plural tracking surfaces is associated with a top density door of the plural density doors and a second of the plural tracking surfaces is associated with a bottom of the plural density doors.

18. The system of claim 12, wherein a first of the plural tracking surfaces is associated with a first upstanding density door of the plural density doors and a second of the plural tracking surfaces is associated with a second, opposing upstanding density door of the plural density doors.

19. A bale density door compression method, the method comprising:
receiving a bale in a chamber comprising plural density doors; and
causing movement by one or more motive apparatuses of a first tracking surface associated with a first bale density door and a second tracking surface associated with a second bale density door, the first and second tracking surfaces on opposing side of the bale.

20. The method of claim 19, wherein causing movement of the first and second tracking surfaces comprises causing movement of the bale concurrently with the movement of the first and second tracking surfaces.
